(19) United States
(12) Patent Application Publication
(10) Pub. No.: US 2016/0094747 A1
(43) Pub. Date: Mar. 31, 2016

(54) POWER SUPPLY CONTROL DEVICE AND METHOD, IMAGE DISPLAY APPARATUS, IMAGE FORMING APPARATUS, AND NON-TRANSITORY COMPUTER READABLE MEDIUM

(71) Applicant: FUJI XEROX CO., LTD., Tokyo (JP)

(72) Inventors: Hidenori HORIE, Kanagawa (JP); Masafumi ONO, Kanagawa (JP)

(73) Assignee: FUJI XEROX CO., LTD., Tokyo (JP)

(21) Appl. No.: 14/604,281

(22) Filed: Jan. 23, 2015

(30) Foreign Application Priority Data
Sep. 26, 2014 (JP) 2014-196870

(51) Int. Cl. H04N 1/00

(52) U.S. Cl. CPC H04N 1/00891; H04N 1/00896; H04N 1/00013; H04N 1/00015; H04N 1/00037; H04N 1/0005; H04N 1/00055; H04N 1/00063; H04N 1/00082; H04N 1/00408; H04N 2201/0094; H04N 2201/0074; H04N 2101/00

(57) ABSTRACT

A power supply control device includes the following elements. A first sensor detects a human near an information processing apparatus which is in a power-saving state. A second sensor detects a human if a human has been detected by the first sensor. A verifying unit verifies a detection state of a human if a human has been detected by the second sensor. A controller controls supply of power to the information processing apparatus so that the power-saving state will be canceled if the detection state of a human has been verified by the verifying unit.

### CROSS-REFERENCE TO RELATED APPLICATIONS

This application is based on and claims priority under 35 USC 119 from Japanese Patent Application No. 2014-196870 filed Sep. 26, 2014.

### BACKGROUND

### Technical Field

The present invention relates to a power supply control device and method, an image display apparatus, an image forming apparatus, and a non-transitory computer readable medium.

### SUMMARY

According to an aspect of the invention, there is provided a power supply control device including the following elements. A first sensor detects a human near an information processing apparatus which is in a power-saving state. A second sensor detects a human if a human has been detected by the first sensor. A verifying unit verifies a detection state of a human if a human has been detected by the second sensor. A controller controls supply of power to the information processing apparatus so that the power-saving state will be canceled if the detection state of a human has been verified by the verifying unit.

### BRIEF DESCRIPTION OF THE DRAWINGS

Exemplary embodiments of the present invention will be described in detail based on the following figures, wherein:

FIG. 1 is a block diagram illustrating an example of the hardware configuration of an image forming apparatus;

FIG. 2 is a flowchart illustrating processing for controlling the operating states by an image forming apparatus according to a comparative example;

FIG. 3 is a block diagram illustrating an example of the functional configuration of an image forming apparatus;

FIG. 4 is a flowchart illustrating an example of processing for controlling the operating states by an image forming apparatus; and

FIG. 5 is a flowchart illustrating another example of processing for controlling the operating states by an image forming apparatus.

### DETAILED DESCRIPTION

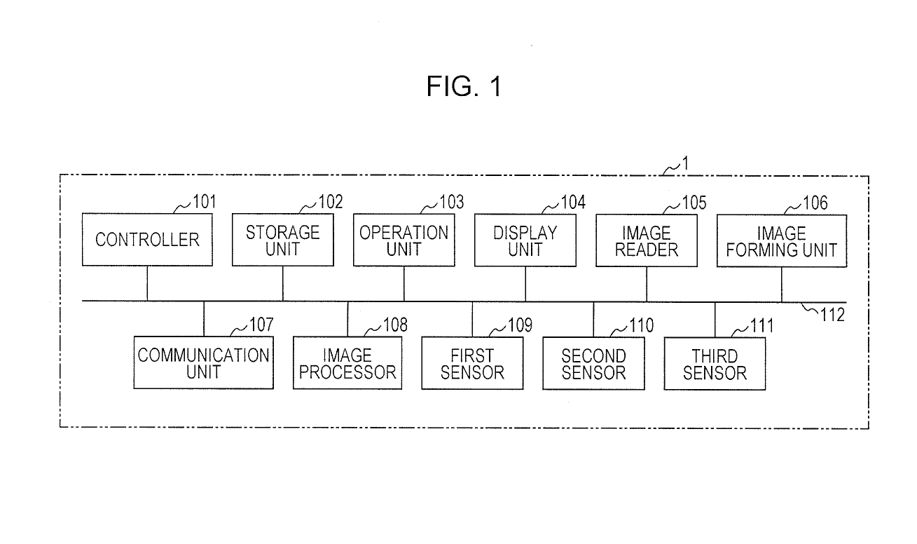

FIG. 1 is a block diagram illustrating an example of the hardware configuration of an image forming apparatus 1 according to an exemplary embodiment of the invention. As shown in FIG. 1, the image forming apparatus 1 is an information processing apparatus including a controller 101, a storage unit 102, an operation unit 103, a display unit 104, an image reader 105, an image forming unit 106, a communication unit 107, an image processor 108, a first sensor 109, a second sensor 110, and a third sensor 111. These elements of the image forming apparatus 1 are connected to a bus 112, and send and receive data to and from each other via the bus 112.

The controller 101 is a device that controls the operations of the individual elements of the image forming apparatus 1. The controller 101 includes a processor, such as a central processing unit (CPU), and storage media (primary storage devices), such as a read only memory (ROM) and a random access memory (RAM). The CPU reads a program stored in the ROM or the storage unit 102 and executes the program by using the RAM as a work area. By executing the program in this manner, the controller 101 implements operations, such as forming (printing) of an image on a sheet (an example of a recording medium), reading of an image from a document (an example of a recording medium) so as to generate image data, and communicating with another apparatus via a communication network. The controller 101 controls the operating states of the display unit 104, the image reader 105, and the image forming unit 106. Examples of the operating states of the display unit 104, the image reader 105, and the image forming unit 106 are a normal state and a power-saving state. In the normal state, more power is supplied to the display unit 104, the image reader 105, and the image forming unit 106 than in the power-saving state. In the power-saving state, less power is supplied to the display unit 104, the image reader 105, and the image forming unit 106 than in the normal state. More specifically, the controller 101 controls the supply of power from a power supply (not shown) to the display unit 104, the image reader 105, and the image forming unit 106 in accordance with signals from the first and second sensors 109 and 110, thereby controlling the operating states of the display unit 104, the image reader 105, and the image forming unit 106. Details of processing for controlling the operating states of the display unit 104, the image reader 105, and the image forming unit 106 will be discussed later.

The storage unit 102 is a device that stores data therein. The storage unit 102 includes storage media (auxiliary storage devices), such as a hard disk and a flash memory, and stores therein data received by the communication unit 107 and data generated by the image forming apparatus 1. The storage unit 102 may include detachable storage media (removable media), such as a memory card or a universal serial bus (USB) memory, and a device for reading and writing data from and into such storage media. The storage unit 102 stores therein a program for controlling the operating states of the display unit 104, the image reader 105, and the image forming unit 106 (hereinafter such a program will be referred to as “a control program”).

The operation unit 103 is a device that receives a user operation. The operation unit 103 includes operators, such as buttons and keys, and supplies a control signal to the controller 101 in accordance with an operator depressed by a user. The operation unit 103 may be constituted by a touch panel which includes the display unit 104 and a sensor disposed on the display screen of the display unit 104 and which supplies a control signal to the controller 101 in accordance with a position at which a user has touched.

The display unit 104 is a device that displays information. The display unit 104 includes, for example, a liquid crystal display, as a display device. The display unit 104 displays images used for operating the image forming apparatus 1 under the control of the controller 101. The display unit 104 is ON in the normal state and is OFF in the power-saving state.

The image reader 105 is a device that reads a document and converts information concerning the read document into image data. The image reader 105 includes an image reading mechanism which optically reads a document and generates image data indicating an image of the read document and a paper feed mechanism which feeds a document to the image reading mechanism. The image reader 105 supplies generated image data to the image processor 108. The image reader 105 is in operation in the normal state and is not in operation in the power-saving state. In this case, “the image reader 105 is in operation” refers to a state in which the image reader 105 is performing setup processing for reading documents (such as adjusting of the paper feed mechanism), feeding of documents, or reading of documents.

The image forming unit 106 is a device that forms an image on a sheet. The image forming unit 106 includes an image forming mechanism which forms toner images of yellow (Y), magenta (M), cyan (C), and black (K) color components on a sheet according to an electrophotographic system and a transport mechanism which transports sheets. The image forming mechanism may form images by using another recording method, such as an inkjet method, instead of the electrophotographic system. The image forming unit 106 is in operation in the normal state and is not in operation in the power-saving state. In this case, “the image forming unit 106 is in operation” refers to a state in which the image forming unit 106 is performing setup processing for forming images (such as adjusting of the transport mechanism), transporting of sheets, or forming of documents.

The communication unit 107 is a device that sends and receives data. The communication unit 107 is connected to a communication network (not shown), and serves as a communication interface which communicates with an external device.

The image processor 108 is a device that performs image processing on image data. In this case, the image processing refers to, for example, color correction and tone correction. When a printing function is executed in the image forming apparatus 1, the image processor 108 supplies image data subjected to image processing to the image forming unit 106.

The first and second sensors 109 and 110 are sensors that detect humans, and upon detecting a human by the first or second sensor 109 or 110, the operating states of the display unit 104, the image reader 105, and the image forming unit 106 are switched. The first sensor 109 is a sensor that detects humans near the image forming apparatus 1, and is, for example, an infrared sensor utilizing the pyroelectricity of a pyroelectric element. The term “near the image forming apparatus 1” refers to a range in which the first sensor 109 or the second sensor 110 is able to detect humans or a range of a predetermined distance from the image forming apparatus 1. The second sensor 110 is a sensor that detects humans near the image forming apparatus 1, and is, for example, a sensor having a camera function of capturing an image of a human. In the second sensor 110, more power is consumed than in the first sensor 109. In an exemplary embodiment of the invention, for reducing power consumption, humans are detected in two steps by using the first and second sensors 109 and 110. More specifically, upon detecting a human by the first sensor 109, the second sensor 110 is started so as to detect the motion of this human. The term “start” or “being started” refers to shifting to the state in which a predetermined function is implemented as a result of receiving power.

Various functions, such as copying, printing, scanning, and fax sending and receiving, in the image forming apparatus 1 are executed after a user is authenticated. The third sensor 111 is a sensor having a camera function for authenticating a user. The third sensor 111 captures an image of a user by using the camera function so as to authenticate the user. More specifically, the third sensor 111 captures an image of a portion unique to an individual user, such as the user's face, in order to detect authentication information from the image of the user. The controller 101 verifies authentication information detected from the image captured by the third sensor 111 against information concerning the characteristics of various faces stored in the storage unit 102, thereby authenticating the user.

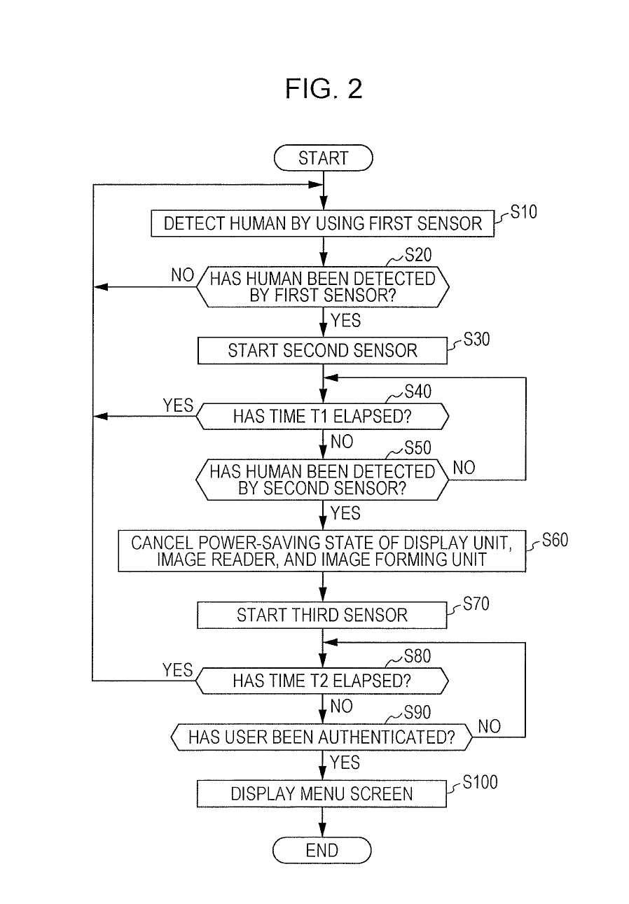

FIG. 2 is a flowchart illustrating processing for controlling the operating states of the display unit 104, the image reader 105, and the image forming unit 106 executed by the image forming apparatus 1 according to a comparative example. In step S10, the controller 101 tries to detect a human by using the first sensor 109. The controller 101 then determines in step S20 whether or not a human has been detected by the first sensor 109 while the display unit 104, the image reader 105, and the image forming unit 106 are in the power-saving state. If it is determined in step S20 that a human has been detected, the process proceeds to step S30. In step S30, the controller 101 starts the second sensor 110. The controller 101 then determines in step S40 whether or not a time T1 has elapsed. If it is determined in step S40 that the time T1 has not elapsed, the process proceeds to step S50. In step S50, the controller 101 determines whether or not a human has been detected by the second sensor 110. If it is determined in step S50 that a human has been detected, the process proceeds to step S60. In step S60, the power-saving state of the display unit 104, the image reader 105, and the image forming unit 106 is canceled. Canceling of the power-saving state refers to returning of the operating states of the display unit 104, the image reader 105, and the image forming unit 106 from the power-saving state to the normal state. Then, in step S70, the controller 101 starts the third sensor 111. It is then determined in step S80 whether or not a time T2 has elapsed. If it is determined in step S80 that the time T2 has not elapsed, the process proceeds to step S90. In step S90, the controller 101 determines whether or not a user has been authenticated. If it is determined in step S90 that the user has been authenticated, the process proceeds to step S100. In step S100, a screen to be operated by the user to use various functions of the image forming apparatus 1 (hereinafter such a screen will be referred to as a “menu screen”) is displayed on the display unit 104.

If the processing shown in FIG. 2 is executed, the following situation may be encountered. It is now assumed that someone passes near the image forming apparatus 1 which is in the power-saving state and turns OFF (or turns ON) a light in the room in which the image forming apparatus 1 is installed. In this case, the motion of this person is detected by the first sensor 109 (the result of step S20 is YES), and then, in step S30, the second sensor 110 is started. If the light in the room is turned OFF (or turned ON) while the second sensor 110 is ON, the second sensor 110 erroneously detects a change in the brightness in the room as the motion of this person (the result of step S50 is YES). Then, in step S60, the controller 101 cancels the power-saving state of the display unit 104, the image reader 105, and the image forming unit 106. In this case, the display unit 104 is turned ON (lit up), and the image reader 105 and the image forming unit 106 are started at an unexpected timing for this person, which may startle this person by the light and sound of the image forming apparatus 1. In the image forming apparatus 1 of an exemplary embodiment of the invention, when a human is detected by the second sensor 110, human detection is performed again, thereby preventing the power-saving state of the display unit 104, the image reader 105, and the image forming unit 106 from being canceled at an unexpected timing for a person who has performed a certain operation irrelevant to the image forming operation, such as turning OFF a light.

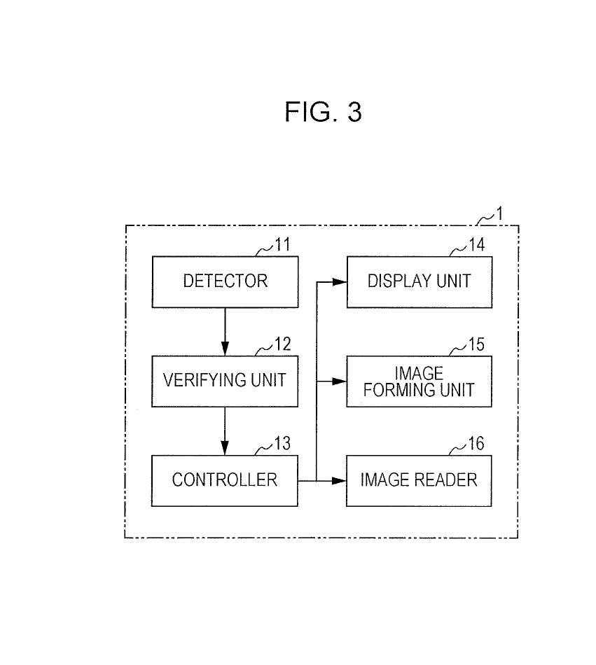

FIG. 3 is a block diagram illustrating an example of the functional configuration of the image forming apparatus 1. The image forming apparatus 1 includes a detector 11, a verifying unit 12, a controller 13, a display unit 14, an image forming unit 15, and an image reader 16. The detector 11 detects humans near the image forming apparatus 1 which is in the power-saving state. Upon detecting a human by the detector 11, the verifying unit 12 verifies the detection state of a human. After the detection state of a human has been verified by the verifying unit 12, the controller 13 controls the supply of power in the image forming apparatus 1 so that the power-saving state will be canceled. If the detection state of a human has not been verified by the verifying unit 12, the controller 13 controls the supply of power in the image forming apparatus 1 so that the power-saving state will be maintained. The display unit 14 displays images used for operating the image forming apparatus 1. The image forming unit 15 forms an image on a sheet. The image reader 16 reads an image from a document. The detector 11, the verifying unit 12, and the controller 13 included in the image forming apparatus 1 are examples of elements forming a power supply control device of an exemplary embodiment of the invention.

The association between the elements of the functional configuration of the image forming apparatus 1 shown in FIG. 3 and the elements of the hardware configuration shown in FIG. 1 is as follows. The first and second sensors 109 and 110 are examples of the detector 11. The first sensor 109, the second sensor 110, and the third sensor 111 are examples of the verifying unit 112. The controller 101 executing the control program is an example of the controller 13. The display unit 104 is an example of the display unit 14. The image forming unit 106 is an example of the image forming unit 15. The image reader 105 is an example of the image reader 16.

### First Exemplary Embodiment

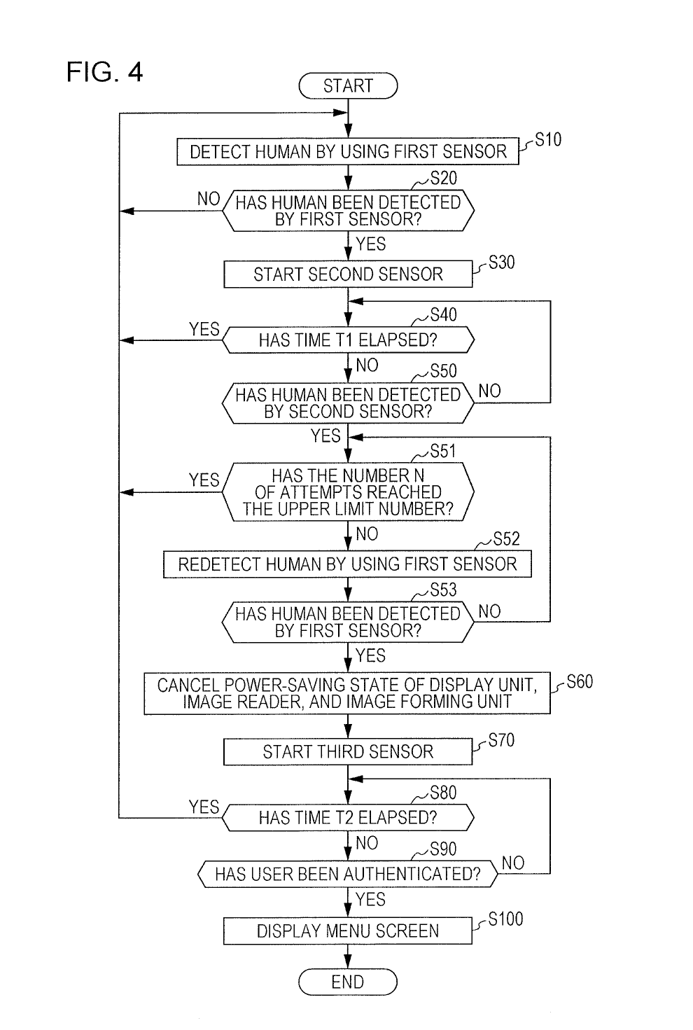

FIG. 4 is a flowchart illustrating an example of processing for controlling the operating states of the display unit 104, the image reader 105, and the image forming unit 106 executed by the image forming apparatus 1 according to a first exemplary embodiment. The processing shown in FIG. 4 is started when the display unit 104, the image reader 105, and the image forming unit 106 are in the power-saving state. At the start point of the processing shown in FIG. 4, the second and third sensors 110 and 111 are not yet started.

In step S10, the controller 101 tries to detect a human by using the first sensor 109. More specifically, the controller 101 determines whether or not a signal indicating that a human has been detected is output from the first sensor 109. The controller 101 then determines in step S20 whether or not a human has been detected by the first sensor 109. If it is determined in step S20 that a human has been detected, the process proceeds to step S30. If it is determined in step S20 that a human has not been detected, the process returns to step S10 and the controller 101 continues to try to detect a human by using the first sensor 109.

In step S30, the controller 101 starts the second sensor 110. The controller 101 then determines in step S40 whether or not a time T1 has elapsed after the start of the second sensor 110. The time T1 is a period from when the second sensor 110 is started until it is stopped, and is stored in the ROM in advance. If it is determined in step S40 that the time T1 has not yet elapsed, the process proceeds to step S50. If it is determined in step S40 that the time T1 has elapsed, the controller 101 stops the second sensor 110 and the process returns to step S10.

In step S50, the controller 101 determines whether or not a human has been detected by the second sensor 110. More specifically, the controller 101 determines whether or not a signal indicating that a human has been detected is output from the second sensor 110. If it is determined in step S50 that a human has been detected, the process proceeds to step S51. If it is determined in step S50 that a human has not been detected, the process returns to step S40.

In step S51, the controller 101 determines whether or not the number N of times the first sensor 109 has tried to detect a human has reached the upper limit number. The determination in step S51 is made for allowing human detection to perform plural times by considering a case in which the first sensor 109 has failed to detect a human in step S53. The initial value of the number N is zero, and every time step S52 is executed, the number N is incremented. The upper limit number is stored in the ROM in advance. If it is determined in step S51 that the number N has not reached the upper limit number, the process proceeds to step S52. If it is determined in step S51 that the number N has reached the upper limit number, the controller 101 stops the second sensor 110 and the process returns to step S10. If the result of step S51 is YES, the controller 101 resets the number N.

In step S52, the controller 101 retries to detect a human by using the first sensor 109. More specifically, the controller 101 monitors a signal output from the first sensor 109 for a predetermined period and determines whether or not a signal indicating that a human has been detected is output from the first sensor 109. In step S53, the controller 101 determines whether or not a human has been detected by the first sensor 109. If it is determined in step S53 that a human has been detected, the controller 101 resets the number N, and the process proceeds to step S60.

In step S60, the controller 101 cancels the power-saving state of the display unit 104, the image reader 105, and the image forming unit 106. When the power-saving state is canceled, the display unit 104 is turned ON, and the image reader 105 and the image forming unit 106 start to perform setup processing.

Then, in step S70, the controller 101 starts the third sensor 111. Then, the third sensor 111 starts to capture an image of the detected person for conducting user authentication. The controller 101 then determines in step S80 whether or not a time T2 has elapsed after the start of the third sensor 111. The time T2 is a period from when the third sensor 111 is started until it is stopped, and is stored in the ROM in advance. If it is determined in step S80 that the time T2 has not elapsed, the process proceeds to step S90. If it is determined in step S80 that the time T2 has elapsed, the controller 101 stops the second and third sensors 110 and 111, and the process returns to step S10.

In step S90, the controller 101 determines whether or not the user has been authenticated. More specifically, the controller 101 detects authentication information from the image captured by the third sensor 111, and verifies the authentication information against information concerning the characteristics of various faces stored in the storage unit 102, thereby authenticating the user. If it is determined in step S90 that the user has been authenticated, the process proceeds to step S100. If it is determined in step S90 that the user has not been authenticated, the process returns to step S80. In step S100, a menu screen is displayed on the display unit 104. The user then starts to use the various functions of the image forming apparatus 1 by operating the menu screen.

According to the above-described processing, if a human has been detected by the second sensor 110, human detection is reattempted by using the first sensor 109. Then, if a human has been redetected, the power-saving state of the display unit 104, the image reader 105, and the image forming unit 106 is canceled. With this processing, even if someone has made a motion irrelevant to the image forming operation, such as turning OFF (or turning ON) a light, the second sensor 110 does not recognize such a motion as the image forming operation. It is thus possible to prevent the power-saving state of the display unit 104, the image reader 105, and the image forming unit 106 from being unnecessarily canceled. As a result, the display unit 104 is not turned ON unexpectedly, nor is sound emitted from the image reader 105 and the image forming unit 106.

### Second Exemplary Embodiment

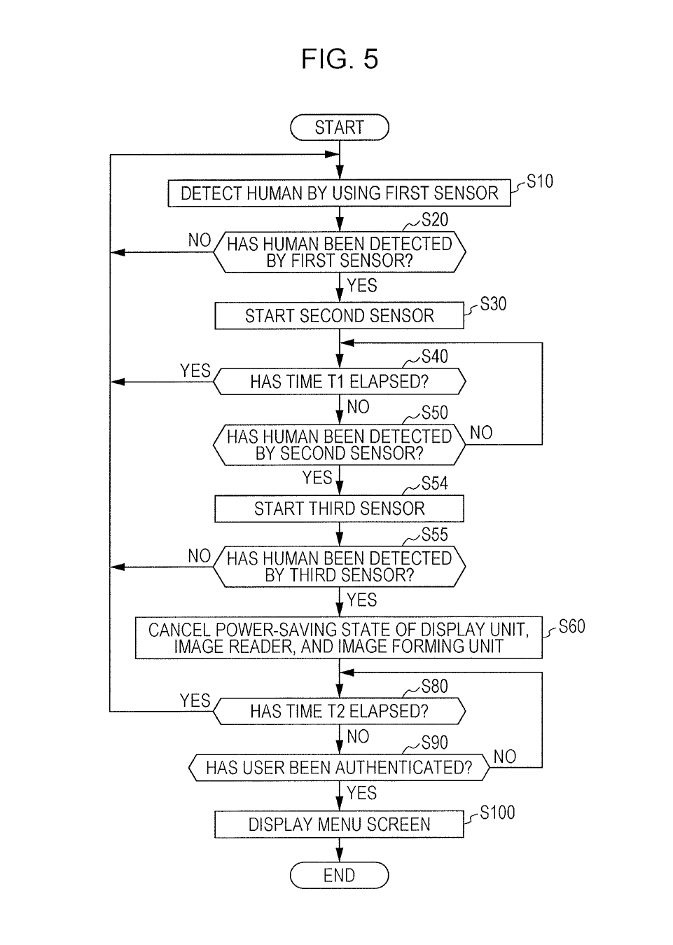

FIG. 5 is a flowchart illustrating another example of processing for controlling the operating states of the display unit 104, the image reader 105, and the image forming unit 106 executed by the image forming apparatus 1 according to a second exemplary embodiment. The processing shown in FIG. 5 is started when the display unit 104, the image reader 105, and the image forming unit 106 are in the power-saving state. At the start point of the processing shown in FIG. 5, the second and third sensors 110 and 111 are not yet started. In the following description, points different from those of the processing shown in FIG. 4 will principally be explained.

If it is determined in step S50 that a human has been detected, the process proceeds to step S54. In step S54, the controller 101 starts the third sensor 111. Then, in step S55, the controller 101 determines whether or not a human has been detected by the third sensor 111. For example, the controller 101 determines in step S55 whether or not a face is included in an image captured by the third sensor 111. If it is determined in step S55 that a human has been detected, the process proceeds to step S60. If it is determined in step S55 that a human has not been detected, the controller 101 stops the second and third sensors 110 and 111, and the process returns to step S10.

According to the above-described processing, if a human has been detected by the second sensor 110, human detection is reattempted by using the third sensor 111. Then, if a human has been redetected, the power-saving state of the display unit 104, the image reader 105, and the image forming unit 106 is canceled. With this processing, even if someone has made a motion irrelevant to the image forming operation, such as turning OFF (or turning ON) a light, the second sensor 110 does not recognize such a motion as the image forming operation. It is thus possible to prevent the power-saving state of the display unit 104, the image reader 105, and the image forming unit 106 from being unnecessarily canceled. As a result, the display unit 104 is not turned ON unexpectedly, nor is sound emitted from the image reader 105 and the image forming unit 106.

The present invention is not restricted to the above-described embodiments, and various modifications may be made. Several modified examples will be discussed below. Among the following modified examples, two or more of the modified examples may be combined.

### (1) First Modified Example

The timing at which the power-saving state of the display unit 104, the image reader 105, and the image forming unit 106 is canceled is not restricted to the timing discussed in the first and second embodiments. For example, the power-saving state of the image reader 105 and the image forming unit 106 may be canceled after a menu screen has been displayed on the display unit 104 in step S100 and an operation for using various functions of the image forming apparatus 1 has been received. Specific examples are as follows. When the user operates the menu screen and inputs an instruction to use a scan function or a fax function, the power-saving state of the image reader 105 may be canceled. When the user operates the menu screen and inputs an instruction to use a print function, the power-saving state of the image forming unit 106 may be canceled. When the user operates the menu screen and inputs an instruction to use a copy function, the power-saving state of the image reader 105 and the image forming unit 106 may be canceled.

### (2) Second Modified Example

The sensor to be used for redetecting humans by the image forming apparatus 1 after a human has been detected by the second sensor 110 is not restricted to the first sensor 109 or the third sensor 111. The image forming apparatus 1 may redetect humans by using the second sensor 110.

### (3) Third Modified Example

The image forming apparatus 1 may control the operating states of elements other than the display unit 104, the image reader 105, and the image forming unit 106. For example, if a processing device for performing processing, such as sorting, stapling, punching, or saddle stitching, on sheets discharged from the image forming apparatus 1, the image forming apparatus 1 may control the operating state of such a processing device. If a paper feeder for feeding paper to the image forming apparatus 1 is connected to the image forming apparatus 1, the image forming apparatus 1 may control the operating state of such a paper feeder.

### (4) Fourth Modified Example

Processing for controlling the operating state according to an exemplary embodiment of the invention may be performed in an information processing apparatus other than the image forming apparatus 1. For example, processing for controlling the operating state according to an exemplary embodiment of the invention may be performed for a display unit in an image display apparatus.

### (5) Fifth Modified Example

In FIG. 4, the number of attempts to redetect a human by the first sensor 109 after a human has been detected by the second sensor 110 in step S50 is not restricted to plural times, and such an attempt may be made only once. In this case, step S51 is omitted, and if it is determined in step S53 that a human has not been detected, the controller 101 stops the second sensor 110, and the process returns to step S10.

### (6) Sixth Modified Example

In step S55 of FIG. 5, a human may be detected by an approach different from that in the second exemplary embodiment. For example, the controller 101 may determine whether or not a human has been detected by detecting whether the human eyes are included in an image captured by the third sensor 111. Alternatively, when there is no one near the image forming apparatus 1, an image is captured by the third sensor 111 in advance. Then, the controller 101 may determine whether or not a human has been detected by comparing this image with an image captured by the third sensor 111 after the third sensor 111 is started in step S54. Alternatively, the controller 101 may determine whether or not a human has been detected by detecting the motion of an object from an image captured by the third sensor 111.

### (7) Other Modified Examples

The hardware configuration of the image forming apparatus 1 is not restricted to the configuration shown in FIG. 1. The hardware configuration of the image forming apparatus 1 may be any configuration as long as the image forming apparatus 1 is capable of executing the steps shown in FIG. 4 or 5.

In the exemplary embodiments, the control program executed by the image forming apparatus 1 may be provided in the state in which it is recorded in a computer readable storage medium, such as a magnetic storage medium (magnetic tape or a magnetic disk (HDD or a flexible disk (FD)), an optical storage medium (optical disc (compact disk (CD) or digital versatile disk (DVD)), a magneto-optical storage medium, or a semiconductor memory (flash ROM). The control program may be downloaded via a network, such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A power supply control device comprising:
a first sensor that detects a human near an information processing apparatus which is in a power-saving state;
a second sensor that detects a human if a human has been detected by the first sensor;
a verifying unit that verifies a detection state of a human if a human has been detected by the second sensor; and
a controller that controls supply of power to the information processing apparatus so that the power-saving state will be canceled if the detection state of a human has been verified by the verifying unit.

2. The power supply control device according to claim 1, wherein the verifying unit verifies the detection state of a human by using the first sensor or the second sensor.

3. The power supply control device according to claim 1, further comprising:
a third sensor,
wherein the verifying unit verifies the detection state of a human by using the third sensor.

4. An image display apparatus comprising:
a display unit that displays an image used for operating the image display apparatus;
a first sensor that detects a human near the image display apparatus in a state in which the display unit is turned OFF;
a second sensor that detects a human if a human has been detected by the first sensor;
a verifying unit that verifies a detection state of a human if a human has been detected by the second sensor; and
a controller that controls supply of power to the display unit so that the display unit will be turned ON if the detection state of a human has been verified by the verifying unit.

5. An image forming apparatus comprising:
an image forming unit that forms an image on a recording medium;
an image reader that reads an image from a recording medium;
a first sensor that detects a human near the image forming apparatus in a state in which at least one of the image forming unit and the image reader is in a power-saving state;
a second sensor that detects a human if a human has been detected by the first sensor;
a verifying unit that verifies a detection state of a human if a human has been detected by the second sensor; and
a controller that controls supply of power to at least one of the image forming unit and the image reader so that the power-saving state of the at least one of the image forming unit and the image reader will be canceled if the detection state of a human has been verified by the verifying unit.

6. A power supply control method comprising:
detecting a human by a first sensor near an information processing apparatus which is in a power-saving state;
detecting a human by a second sensor if a human has been detected by the first sensor;
verifying a detection state of a human if a human has been detected by the second sensor; and
controlling supply of power to the information processing apparatus so that the power-saving state will be canceled if the detection state of a human has been verified.

7. A non-transitory computer readable medium storing a program causing a computer having a first sensor and a second sensor to execute a process, the process comprising:
detecting a human by the first sensor near the computer which is in a power-saving state;
detecting a human by the second sensor if a human has been detected by the first sensor;
verifying a detection state of a human if a human has been detected by the second sensor; and
controlling supply of power to the computer so that the power-saving state will be canceled if the detection state of a human has been verified.
